(19) United States
(12) Patent Application Publication
(10) Pub. No.: US 2004/0264174 A1
(43) Pub. Date: Dec. 30, 2004

(54) Light having a minus-ion generator

(76) Inventor: Tetsushiro Tsuchiya, Boulder, CO (US)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/608,125

(22) Filed: Jun. 30, 2003

(51) Int. Cl. F21V 21/08

(52) U.S. Cl. 362/103

(57) ABSTRACT

There is provided a light comprising a body, a light source provided on the body, an attaching part extending from the body. The light also has a minus ion material formed on the body. The minus ion material is selected from the group consisting of tourmaline, activated charcoal, a mineral of rare earth metal, and a mineral of silicate. The body may be shaped into a cylinder having a front surface, a back surface, and a side surface extending between the front surface and the back surface. The light may further have a reflector formed on the front surface in a manner to surround the light source. The light also may have a clock provided on the body formed on the side surface of the body. The minus ion material of the present invention shields electromagnetic waves.

### FIELD OF THE INVENTION

The present invention relates to a light for, for example, reading. The present invention also relates to a light having a minus ion material to relax a user, the minus ion material shielding electromagnetic waves. The light of the present invention may be designed into any applications including watch, health care goods, electronics, communication tool, outdoor goods and so on.

### OBJECTIVE OF THE PRESENT INVENTION

It has been remarked that minus ions make a human being relax, activating a living cell. As a process to generate minus ions, there have been known as follows: (1) A Leonard's effect is known as a process to generate minus ions at a cascade. (2) A discharge or a radiation is also known to generate minus ions. (3) Also, a minus ion material, such as tourmaline and activated carbon, is known to generate minus ions in a weak level.

Among them, the minus ion material has recently remarked, since it generates minus ions continuously, so good cost value is expected. Tourmaline is one of hopeful minerals. Tourmaline generates a minus ion, a weak current, and a far-infrared ray. An activated charcoal, such as Binchotan charcoal, is also known to generate minus ions, but the amount discharged from an activated charcoal is extremely small. It has been studied to put such a minus ion material into a practice, incorporating it into an equipment which is ordinary used in our dairy life. However, minus ions generated from such a material is so weak compared with a Leonard's effect, and there has been an objective to increase an amount of the generating of minus ions.

On the other hand, as various electric appliances which are designed for miniaturization and carriage have been widespread, it has been concerned that electromagnetic waves generated from the electric appliances adversely affect a user. Therefore, it has been studied to shield electromagnetic waves, especially, with respect to portable electric devices, such as watch, health care goods, electronics, communication tool, outdoor goods and so on.

### SUMMARY OF THE INVENTION

The inventor of the present invention has focused on the objective, and finally invented the present invention. According to the present invention, there is provided a light comprising a body, a light source provided on the body, an attaching part extending from the body. The attaching part installs the light for lighting. The light also has a minus ion material formed on the body. The minus ion material is selected from the group consisting of tourmaline and activated charcoal. In addition, the minus ion material may be mixed with a mineral of rare earth metal including monazite, a mineral of silicate and so on. The body may be shaped into a cylinder having a front surface, a back surface, and a side surface extending between the front surface and the back surface. The light may further have a reflector formed on the front surface in a manner to surround the light source. The light also may incorporate a timekeeping function provided on the body formed on the side surface of the body. The light may further comprise a cover on the front surface to cover the light source.

According to the present invention, the light has an attaching part to install the light at a portion where a user wishes to place.

### BRIEF DESCRIPTION OF THE PRESENT INVENTION

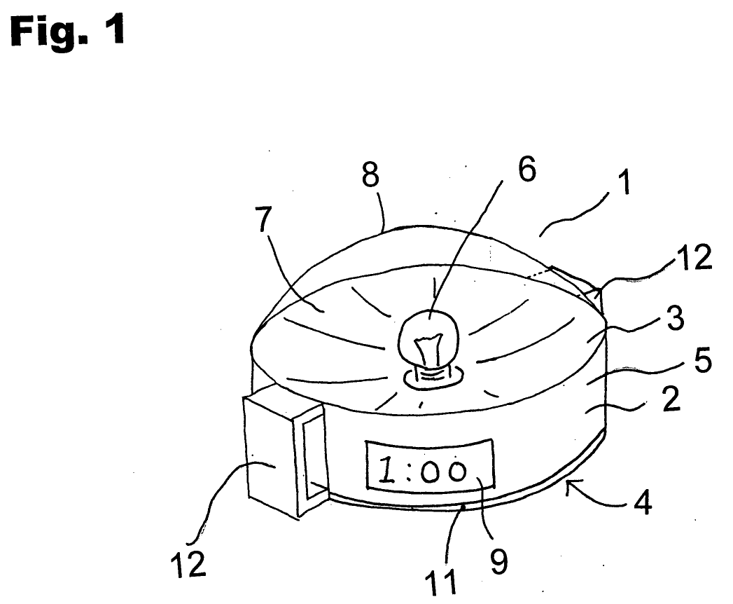

FIG. 1 shows a perspective view of the light according to the present invention.

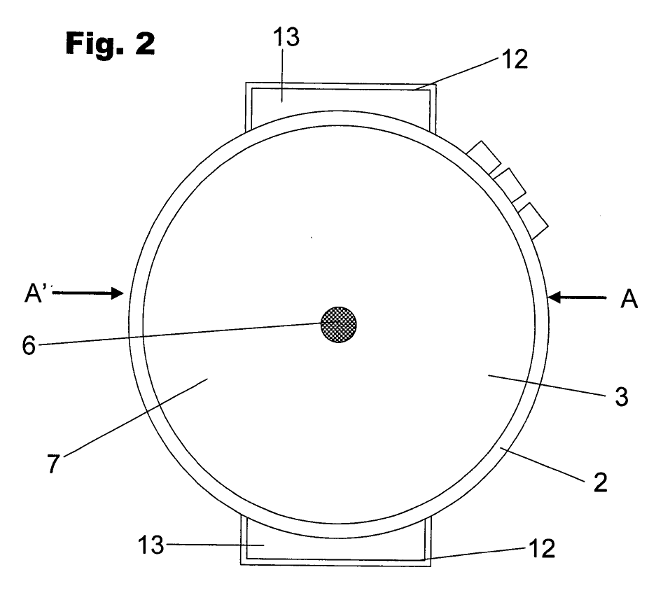

FIG. 2 shows a top view of the light according to the present invention.

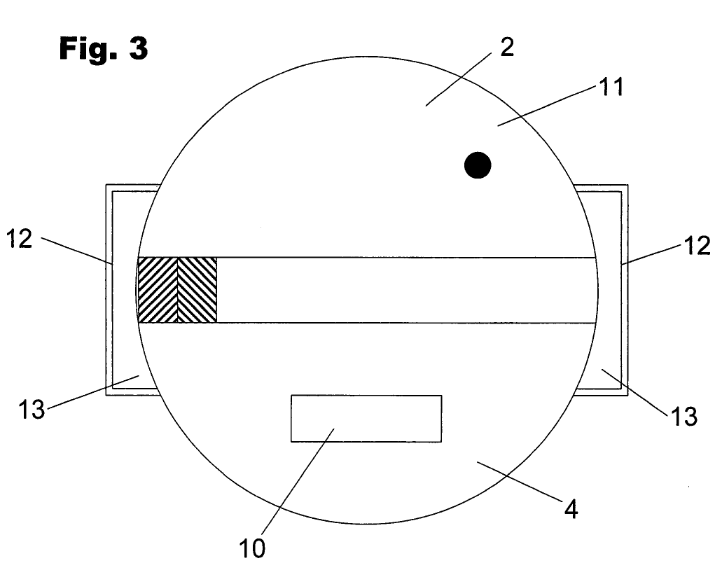

FIG. 3 shows s a back view of the light according to the present invention.

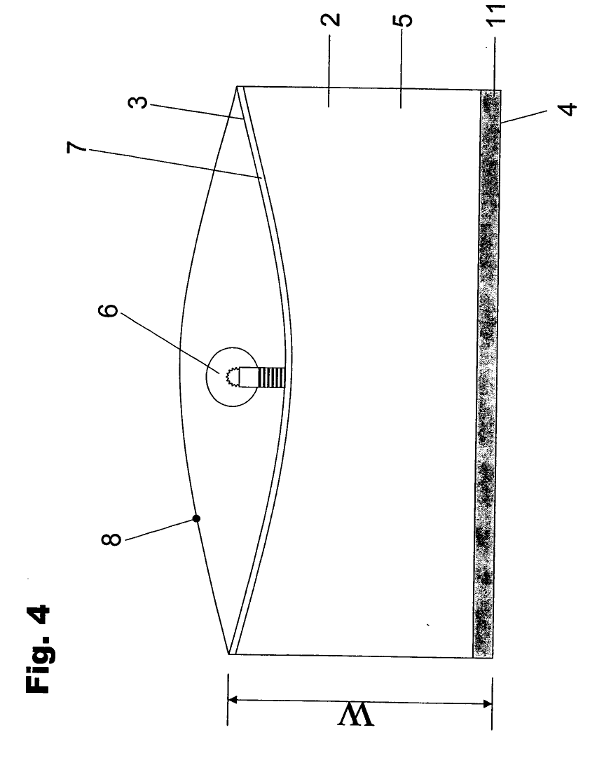

FIG. 4 shows a cross-sectional view of FIG. 2.

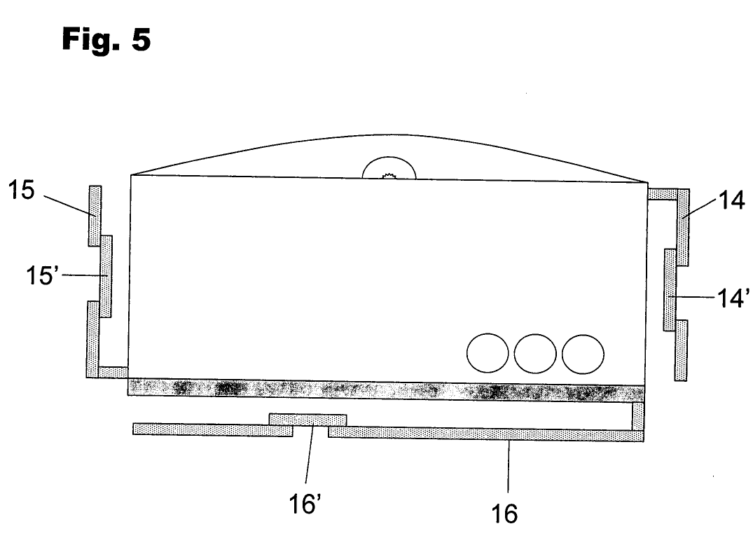

FIG. 5 shows a plan view of another embodiment.

### DETAILED DESCRIPTION OF THE PRESENT INVENTION

As shown in FIGS. 1-4, the light of the present invention has a body. The body 2 is shaped into a cylinder. The body 2 has a front surface 3, a back surface 4, and a side surface 5 extending between the front surface and the back surface. The front surface 3 is designed to engage an electric bulb 6 in the center thereof. The body 2 has a width “w” between the front surface and the back surface. The width “w” is not limited, but the width is preferably ranging between 0.1 to 3 cm, and more preferably, between 0.3 to 2 cm. The material forming the body is not limited, but it is preferable to use a material controlling heat transmittance between the light source and a portion where the minus ion generating material is.

In the center of the front surface, a light source 6 is provided. There is provided a reflector 7 formed on the front surface 3 in a manner to surround the light source 6. The reflector 7 reflects a light from the light source 6. The light source 6 is covered with a transparent cover 8 provided on the front surface.

There is provided a liquid crystal display 9 on the side surface of the body. The light of the present invention incorporates a time keeping function so as to display a current time. Alternatively, the display may be formed on the back surface or the front surface of the body. Alternatively, the display may be provided on the cap as described hereinafter. The time keeping function has a digital movement, but the present invention is not limited thereto, and the time keeping function may be in an analogue type.

In addition, the light of the present invention has a means of measuring a pulse, a blood pressure, and/or a body temperature. A sensor 10 is provided on the back surface of the body as shown in FIG. 3. The sensor receives information of a pulse, blood pressure, and body temperature of the user. The information is treated in a chip provided in the body, and displayed on the liquid crystal display.

According to the present invention, the light has a layer of a minus ion material 11. The minus ion material 11 may be provided on the back surface, and in addition, it may be provided on the side surface and/or front surface of the body. The minus ion material may comprise a minus ion ceramics, including tourmaline and activated charcoal. Also, a mineral of rare earth element including monazite, a mineral of silicate, and feldspar may be used. In addition, any material generating minus ions may be used in this present invention. These substances may be used alone or in combination. Among them, tourmaline, and in particular, a minus ion ceramics including tourmaline and a ceramics, is preferably used. It is also preferable to use a ceramics generating a far infrared ray. In general, a minus ion ceramics, which is commercially available, may be preferably used. The minus ion ceramics is a mixture of tourmaline and a ceramics. The minus ion material may be mixed with a mineral of rare earth metal including monazite, a mineral of silicate and so on, if necessary.

According to the present invention, the minus ion material is in a form of powder, having a particle size of 1 to 1000 μm, and in particular, of 2 to 500 μm.

According to the present invention, a preferable minus ion material may be prepared in a form of paint. Paint as a minus ion material may be prepared into a composition comprising a minus ion material, a resin powder, a solvent, and optionally, a filer. The paint may be coated on the side surface and/or the back surface of the body, followed by drying. Instead of a paint formula, the minus ion material may be formed into a resin board, by mixing it with a polymer followed by curing. In case of the resin board including the minus ion material, the board is formed into a specific shape applicable to the body of the light. The resin board may be attached on the body by an adhesive, a screw and so on.

Alternatively, the minus ion material is included in a material composed of the body. In this case, the method for preparing the body depends on the material of the body. For example, the body is made of a resin, the minus ion material is included in a resin composition. In addition, the minus ion material may be included in the cover as described above. Further, the minus ion material may be provided in additional part, which is not described here. The light of the present invention may be variously designed to have additional part. The additional part may include a cap provided on the front surface of the body. The cap is attached on the front surface, closing the front surface of the light when the light is not used, and opening the front surface when the light is used. The minus ion material may be included in, or coated on, the cap.

According to the present invention, the minus ion material 11 is distanced from the light source 6. By giving an appropriate distance, the minus ion material 11 is raised into a specific temperature for sufficiently activating it, so as to generate minus ions efficiently. According to the present invention, it is preferably to provide a distance between the light source and the minus ion material of 0.3 cm to 3.0 cm, and in particular, of 0.3 to 2.0 cm, and more preferably, of 0.3 to 1.5 cm. By providing such a distance, the minus ion material 11 is raised at a preferable temperature ranging as described later.

In addition, the minus ion material of the present invention shields electromagnetic waves. Since the minus ion material is provided at least on the back surface, electromagnetic waves generated from the light are shielded by the minus ion material of the present invention. In addition, the minus ion material may be formed on the side surface and/or the front surface of the body. While the mechanism of the shielding of electromagnetic waves has not been clarified yet, the minus ion material such as tourmaline has a crystal structure having electric charges, which may absorb electromagnetic waves. The mechanism of the shielding of electromagnetic waves does not limit the scope of the present invention. Even if the mechanism the inventor of the present invention considers will be turned out to be wrong, the present invention should not be construed to be limited into the mechanism described here.

As a light source 6, an electric bulb is preferably used, having a watt of 0.1 to 50 W, and preferably, 0.3 of 10 W. The light may be preferable to be designed into a reading light having a relatively small illumination for partially lighting, which is easy for a user to carry in commutating, traveling, and working.

According to the present invention, the minus ion material may be raised at a temperature of 30 to 50° C., and in particular, at a temperature of 35 to 45° C. Such a range of the temperature is preferable to activate the minus ion material, generating minus ions efficiently. According to the present invention, when the light is turned on, the portion where the minus ion material is provided is raised, to activate it to increase the generated amount of minus ions.

In addition, the minus ion material 11 is provided on the back surface of the body, thereby generating friction between the minus ion material 11 and a user. The present inventor found that friction is very effective to generate minus ions.

As described above, the light of the present invention has a means of measuring a pulse, a blood pressure, and/or a body temperature. Where the light is provided with a means of measuring a pulse, a blood pressure, and/or a body temperature, the body of the light is raised by a use's body temperature, even if the light is in a condition of being turned off. Thus, in a case of raising the light of the present invention by a user's body temperature, the minus ion material is preferably raised at a temperature of 35 to 45° C., eventually activating the material to increase an amount of minus ions generated.

The light of the present invention as shown in FIG. 1 has an engaging portion 12, forming a hole 13, into which, for example, a chain or a string is provided, so that a user wear the light or put it on its clothes. It would be useful when a user reads a book in a gloomy room including as a plane and a car. Also, it would be useful when a user may use it in an outdoor leisure, such as night camp, night fishing, and so on. The light of the present invention may also incorporate means to measure an atmosphere pressure.

Alternatively, FIG. 4 is another embodiment of the present invention. The embodiment has an attaching part 14, 15, 16 to install the light at a portion where the user wishes to light. As shown in FIG. 4, the attaching part comprises a first arm 14 extending along the side surface from the periphery of the front surface of the body; a second arm 15 extending along the side surface from the periphery of the back surface of the body; and a third arm 16 extending along the back surface from the periphery of the back surface. Each of the arms has an engaging portion 14,′ 15,′ 16,′ at the end of each arms. The arm or the engaging portion is given a spring load in the direction of the body. The attaching part installs the light at an installed portion depending on a user's intent. The installed portion may include a pocket of the user's clothes, a shelf, a book, and so on.

In addition to the engaging portion described in this specification, the light of the present invention may be provided with a modified engaging portion, so long as it gives a structure to engage the light to a user. One skill in the art may modify the engaging portion within scope of the present invention.

The light of the present invention has various applications. For example, the light may be designed into a pendant, so that friction is created between the minus ion material and user's clothes. Alternatively, the light may be designed into a broach. Friction in combination with the heat of the user's body promotes to generate minus ions. Since the minus ion material shields electromagnetic waves, the user may be safer even if wearing the light for a long time.

Alternatively, the light of the present invention may be designed into a watch. In this application, the light of the present invention may be provided with a watch belt, so as to form a watch. The watch belt is provided on the hole 13 of the engaging portion 12. When the light is designed into a watch, friction is created between the minus ion material and user's skin, so as to activate the minus ion material. In addition, the minus ion material shields electromagnetic waves, so that the user is less affected by electromagnetic waves.

In addition, the light of the present invention may be designed into a communication tool, such as a portable telephone and a telecommunication. In such an application, a microphone and a speaker may be provided on the side surface of the body. Further, the light of the present invention may have a function of electronics such as a personal computer, allowing portable use. The minus ion material generates minus ions while shielding electromagnetic waves, so that the user is made relaxed and less affected by electromagnetic waves.

In the above description, the body is described to have a shape of a cylinder, but the present invention does not limit thereto. The light of the present invention may be formed into a various shape other than a cylinder.

As described above, the light of the present invention is provided with the minus ion material to generate minus ions, for relaxing a user. In addition, the minus ion material of the present invention shields electromagnetic waves. The present invention may be useful not only for the light as described here, but also for any electric appliances, especially, ones modified into a miniaturized carriage type.

The present invention is described in detailed based on embodiments, but the present invention should not be construed into the embodiment described in the specification of the present invention. In addition to the description in the specification of the present invention, one skilled in the art may modify the present invention within the scope of the present invention as defined in the attached claims.

What is claimed is:

1. A light comprising:
a body having a front surface, a back surface, and a side surface extending between the front surface and the back surface, the body having a width between the front surface and the back surface;
a light source provided on the center of the front surface;
a reflector formed on the front surface to surround the light source; and
a minus ion material provided on the back surface of the body, the minus ion material being at least one selected from the group consisting of tourmaline, activated charcoal, a mineral of rare earth metal and a mineral of silicate;
wherein the back surface of the body contacts a user of the light, and wherein the minus ion material is raised at a temperature of 25 to 50° C.

2. A light according to claim 1, wherein the light is designed into a pendant, and wherein the back surface of the body contacts clothes of the user.

3. A light according to claim 1, further comprising a timekeeping function.

4. A light according to claim 1, wherein the light is designed into a watch, and wherein the back surface of the body contacts a skin of the user.

5. A light according to claim 1, further comprising a display provided on the side surface of the body.

6. A light according to claim 1, wherein the light is designed into a broach.

7. A light according to claim 1, further comprising a means of measuring a pulse, a blood pressure, and/or a body temperature.

8. A light comprising;
a body;
a light source provided on the body;
an attaching part provided on the body; and
a minus ion material provided on the body, wherein the minus ion material is selected from the group consisting of tourmaline, activated carbon, a mineral of rare earth metal, and a mineral of silicate.

9. A light according to claim 8, wherein the body has a front surface, a back surface, and a side surface extending between the front surface and the back surface; and wherein the front surface forms a reflector in a manner to surround the light source.

10. A light according to claim 8, wherein the light is designed into a pendant, and wherein the back surface of the body contacts clothes of a user.

11. A light according to claim 8, further comprising a timekeeping function.

12. A light according to claim 8, wherein the light is designed into a watch, and wherein the back surface of the body contacts skins of a user.

13. A light according to claim 8, further comprising a means of measuring a pulse, a blood pressure, and/or a body temperature.

14. A light comprising;
a body;
a light source provided on the body;
an attaching part extending from the body, wherein the attaching part installs the light to a user; and
a minus ion ceramics provided on the body, wherein the minus ion ceramics is provided in a manner to be activated by heat of, and friction with, the user, and wherein the minus ion material shields electromagnetic waves.

15. A light according to claim 14, wherein the light is designed into a pendant, and wherein the body contacts clothes of the user.

16. A light according to claim 14, wherein the light is designed into a portable telephone.

17. A light according to claim 14, further comprising a timekeeping function.

18. A light according to claim 14, wherein the light is designed into a watch, and wherein the back surface of the body contacts skins of the user.

19. A light according to claim 14, further comprising a means of measuring a pulse, a blood pressure, and/or a body temperature.

20. A light according to claim 14, wherein the light is designed into a portable personal computer.
